(19) United States
(12) Patent Application Publication
(10) Pub. No.: US 2018/0348797 A1
(43) Pub. Date: Dec. 6, 2018

(54) FLUID CONTROL VALVE DEVICE

(71) Applicants: ADVICS CO., LTD., Kariya-shi, Aichi (JP); TOYOTA JIDOSHA KABUSHIKI KAISHA, Toyota-shi, Aichi (JP)

(72) Inventors: Yusuke KAMIYA, Okazaki-shi, Aichi-ken (JP); Takahiro OKANO, Chiryu-shi, Aichi-ken (JP)

(73) Assignees: ADVICS CO., LTD., Kariya-shi, Aichi (JP); TOYOTA JIDOSHA KABUSHIKI KAISHA, Toyota-shi, Aichi (JP)

(21) Appl. No.: 15/778,982

(22) PCT Filed: Nov. 25, 2016
(86) PCT No.: PCT/JP2016/085064

§ 371 Date: May 24, 2018

(30) Foreign Application Priority Data
Nov. 27, 2015 (JP) 2015-231605

(51) Int. Cl. G05D 7/06; F16K 31/122; F16K 31/124; G05B 19/045

(52) U.S. Cl. CPC G05D 7/0635; F16K 31/1221; B60T 13/686; G05B 19/045; G05B 2219/25312; F16K 31/124

(57) ABSTRACT

A fluid control valve device includes a spool valve, a control valve, a control unit, and storage. The spool valve has an introduction port, a discharge port, and a supply port. The control unit controls the open or closed state of the control valve according to a command value. The storage stores past data on at least one of a control value by which the control unit controls the control valve, a value calculated by the control unit, and a detection value of a sensor. The control unit changes, according to the past data, the open or closed state of the control valve based on the command value.

### CROSS-REFERENCE TO RELATED APPLICATIONS

This application is national stage application of International Application No. PCT/JP2016/085064, filed Nov. 25, 2016, which designates the United States, incorporated herein by reference, and which is based upon and claims the benefit of priority from Japanese Patent Application No. 2015-231605, filed Nov. 27, 2015, the entire contents of which are incorporated herein by reference.

### TECHNICAL FIELD

The present invention relates generally to a fluid control valve device.

### BACKGROUND ART

Conventionally known fluid control valve devices include a spool valve that electrically controls open and closed positions of a pressure increasing valve and a pressure reducing valve to adjust a pilot pressure, thereby adjusting pressure and a flow rate of a fluid to be supplied to an object to control (for example, Patent Document 1).

### CITATION LIST

### Patent Literature

Patent Document 1: International Publication No. WO2015/080277

### SUMMARY OF INVENTION

### Problem to be Solved by the Invention

In such a fluid control valve device, however, a problem in movement of a spool in the spool valve may lead to, for example, undesirable inconveniences including lowering responsiveness to changes in the pressure and the flow rate of the supply of the fluid to the object to control. It is therefore an object of the present invention to attain a fluid control valve device that includes a spool valve that allows the spool to move more smoothly, for example.

### Means for Solving Problem

A fluid control valve device of the present invention includes, for example, a spool valve including: a housing; and a spool housed in the housing so as to be movable in a first direction and a second direction opposite to the first direction, the housing and the spool defining a control pressure chamber and a supply pressure chamber, the control pressure chamber that applies a control pressure that gives the spool a force to move in the first direction and the supply pressure chamber that applies a supply pressure that gives the spool a force to move in the second direction, the housing provided with an introduction port, a discharge port, and a supply port, the introduction port that is opened to introduce fluid into the supply pressure chamber when the spool moves in the first direction and is closed when the spool moves in the second direction, the discharge port that is opened to discharge the fluid from the supply pressure chamber when the spool moves in the second direction and is closed when the spool moves in the first direction, and the supply port that supplies the fluid from the supply pressure chamber to an object to control; a control valve that changes an open or closed state to control pressure in the control pressure chamber; a control unit that controls the open or closed state of the control valve in accordance with a command value; and storage that stores therein past data on at least one of a control value by which the control unit controls the control valve, a value calculated by the control unit, and a detection value of a sensor, wherein the control unit changes, according to the past data, the open or closed state of the control valve based on the command value.

In the fluid control valve device, the control unit changes, according to the past data, the open or closed position of the control valve based on the command value. Thus, even when the spool is hard to move depending on a movement history of the spool, for example, the control unit can move the spool more swiftly to thereby more promptly vary pressure or flow rate of the fluid to be supplied to the object to control.

In the fluid control valve device, the control unit temporarily corrects the control value based on the command value when estimating a reversal of a moving direction of the spool.

In the fluid control valve device, even when, for example, the spool is hard to move due to a change in the direction of the sliding resistance to the spool, the control unit can move the spool more swiftly to thereby more promptly vary the pressure or flow rate of the fluid to be supplied to the object to control.

In the fluid control valve device, the control unit temporarily corrects the control value based on the command value when estimating a reversal of the moving direction of the spool before and after a stop of the spool.

In the fluid control valve device, even when, for example, the spool is hard to move due to a change in the direction of the sliding resistance to the spool before and after a stop of the spool, the control unit can move the spool more swiftly to thereby more promptly vary the pressure or flow rate of the fluid to be supplied to the led object to control.

In the fluid control valve device, the control unit temporarily corrects the control value based on the command value such that a force at least twice a sliding resistance, which acts on the spool, acts on the spool.

In this case, the sliding resistance force can act in the opposite direction due to the difference in pressure of fluids as a result of changes in the open or closed position of the control valve, and the force acting on the spool in the reversed moving direction approaches the equilibrium. Thus, the control unit can, for example, move the spool more swiftly to thereby more promptly vary the pressure or flow rate of the fluid to be supplied to the object to control.

In the fluid control valve device, the control unit estimates a position of the spool and determines whether to temporarily correct the control value based on the command value, according to the estimated position of the spool.

In this case, the control unit can determine the necessity of correction of the control amount (control value) more accurately on the basis of the estimated position of the spool, for example.

### BRIEF DESCRIPTION OF DRAWINGS

FIG. 1 is a schematic exemplary configuration diagram illustrating a fluid control valve device in one embodiment;

FIG. 2 is a schematic exemplary configuration diagram illustrating a spool valve of the fluid control valve device in the embodiment, when the spool valve is in a different state from that in FIG. 1;

FIG. 3 is a schematic exemplary configuration diagram illustrating the spool valve of the fluid control valve device in the embodiment, when the spool valve is in a different state from that in FIGS. 1 and 2;

FIG. 4 is a schematic exemplary block diagram illustrating a general configuration of a controller of the fluid control valve device in the embodiment;

FIG. 5 is an exemplary flowchart illustrating steps performed by a correction necessity determiner and a control amount corrector of the fluid control valve device in the embodiment; and

FIG. 6 is an exemplary graph depicting changes with time in valve flow rate, spool position, and fluid pressure in different chambers when the fluid control valve device of the embodiment are controlled to be in different states transitioning from pressure increasing to pressure maintaining, and returning to pressure increasing.

### DESCRIPTION OF EMBODIMENTS

An exemplary embodiment of the present invention will be disclosed below. The configuration of the embodiment described below and actions and results (effects) achieved by the configuration are for illustrative only. The present invention can also be achieved by any configuration other than the configuration disclosed in the embodiment described below. The present invention can achieve at least one of various effects (including derivative effects) to be achieved by the configuration. In this specification, ordinal numbers are used to simply distinguish components or parts and regions and are not intended to indicate any order of priority or precedence.

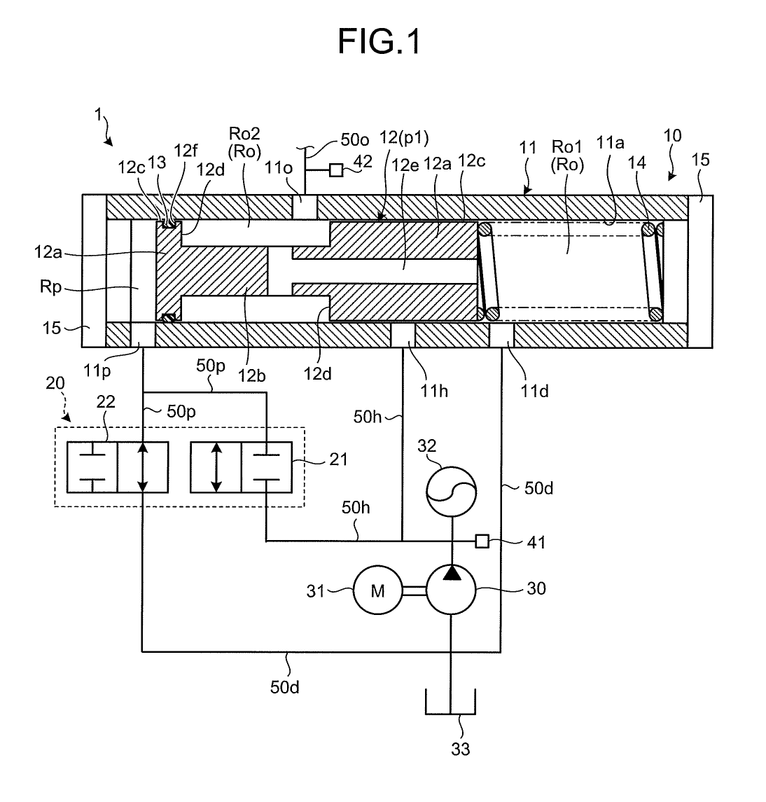

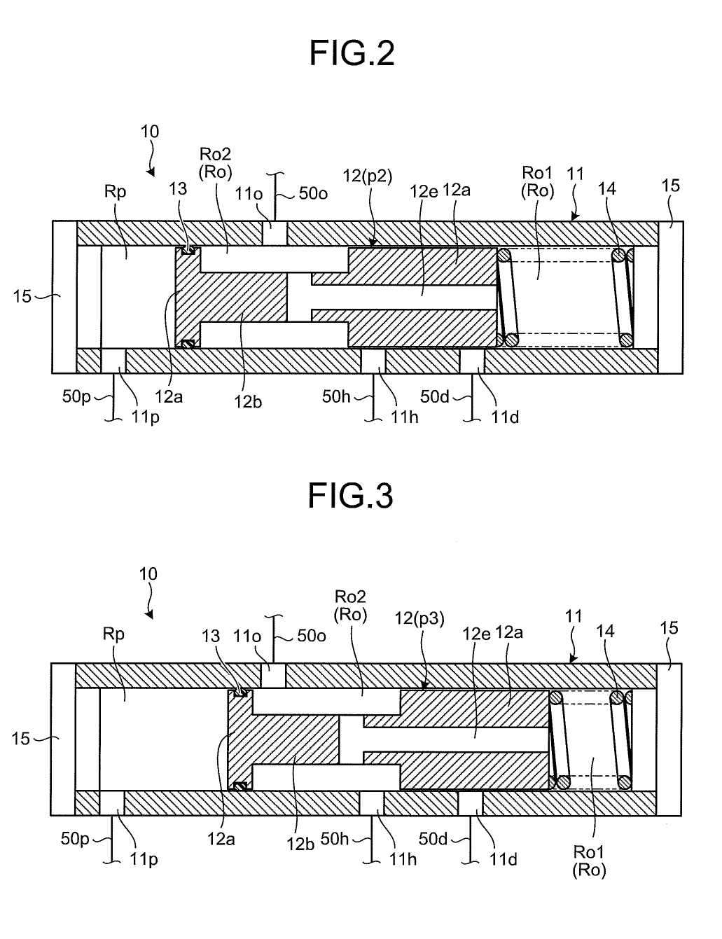

Configuration of Fluid Control Valve Device FIG. 1 is a general configuration diagram illustrating a fluid control valve device 1. FIGS. 2 and 3 are general configuration diagrams illustrating a spool valve 10 of the fluid control valve device 1. As illustrated in FIG. 1, the fluid control valve device 1 includes the spool valve 10 and a control valve 20. The control valve 20 is changed in open or closed position by electrical control. The spool valve 10 changes the position of a spool, that is, an open or closed position of the spool valve 10 in accordance with the change in the open or closed position of the control valve 20. Specifically, the fluid control valve device 1 controls the open or closed position of the spool valve 10 via the control valve 20 using an electric signal, to thereby vary pressure or a flow rate of a fluid such as hydraulic oil to supply via the spool valve 10. The fluid control valve device 1 may be applied to, for example, a valve that controls pressure or a flow rate of hydraulic oil supplied to a master cylinder of a vehicle brake system, but is not limited thereto.

As illustrated in FIG. 1, the spool valve 10 includes a housing 11 and a spool 12. The housing 11 has a cylinder face 11a. In the example illustrated in FIG. 1, the cylinder face 11a is an inner surface (lateral surface) of a through hole that passes through the housing 11. Both axial ends of the cylinder face 11a are closed with plugs 15, thereby defining a chamber inside the housing 11. The plugs 15 also constitute part of the housing 11. The housing 11 may be referred to as a sleeve. The spool 12 may be referred to as a valve element. The cylinder face 11a may be simply referred to as a cylinder. The cylinder face 11a may be an inner surface of a hole with only one axial end open. In other words, the number of plugs 15 may be one.

The spool 12 is housed axially movably inside the cylinder face 11a. The spool 12 includes two large-diameter parts 12a and a small-diameter part 12b. The small-diameter part 12b is disposed between the two large-diameter parts 12a. A clearance between outer surfaces 12c of the large-diameter parts 12a and the cylinder face 11a may be set to, for example, about 10 micrometers. The small-diameter part 12b is a recess 12d extending annularly along the circumference of the spool 12. The housing 11 is provided with a chamber Ro2 between the small-diameter part 12b and the cylinder face 11a.

One of the two large-diameter parts 12a, i.e., the left large-diameter part 12a in the axial direction in FIG. 1 has an annular groove 12f in the outer surface 12c. The groove 12f accommodates a seal member 13 formed of, for example, an elastic material such as elastomer. The seal member 13 is disposed between the spool 12 and the cylinder face 11a to seal one side and the other side in the axial direction of the seal member 13. In this case, the seal member 13 prevents leakage of fluid between a chamber Rp and the chamber Ro2. The seal member 13 gives sliding resistance to the spool 12 while the spool 12 moves in the cylinder face 11a.

The housing 11 includes the chamber Rp on one side in the axial direction of the spool 12, i.e., the left side in FIGS. 1 to 3. The chamber Rp is surrounded by the cylinder face 11a, the plug 15, and the large-diameter part 12a on one side in the axial direction of the spool 12. The chamber Rp communicates with the control valve 20 via a port lip and a passage 50p regardless of the position of the spool 12. The chamber Rp is an exemplary control pressure chamber and may be referred to also as a pilot pressure chamber. The spool 12 receives a force from a fluid pressure in the chamber Rp to the other side in the axial direction. The fluid pressure in chamber Rp is exemplary control pressure and the other side in the axial direction is an exemplary first direction. The housing 11 or the spool 12 includes a not-illustrated movement limiter. The movement limiter restricts the spool 12 from moving to one side in the axial direction, that is, leftward in FIG. 1 with respect to a position p1 in FIG. 1.

The housing 11 includes a chamber Ro1 on the other side in the axial direction of the spool 12, i.e., on the right side in FIGS. 1 to 3. The chamber Ro1 is surrounded by the cylinder face 11a, the plug 15, and the large-diameter part 12a on the other side in the axial direction of the spool 12. The chamber Ro1 accommodates a coil spring 14 as an elastic member. The coil spring 14 is elastically extendable and contractible in the axial direction to thereby give the spool 12 an elastic compressive reaction toward one side in the axial direction. The coil spring 14 is an exemplary urging member.

The chamber Ro1 communicates with the chamber Ro2 via a passage 12e in the spool 12. The chamber Ro1 communicates with the chamber Ro2 via the passage 12e having a relatively low resistance, so that a fluid pressure in the chamber Ro1 can be regarded substantially same as a fluid pressure in the chamber Ro2. Thus, the chamber Ro1 and the chamber Ro2 can be regarded as the same chamber Ro. The chamber Ro1 and the chamber Ro2 may communicate with each other via a passage in the housing 11. The chamber Ro is an exemplary supply pressure chamber and may be referred to also as a servo pressure chamber. The spool 12 receives a force from the fluid pressure in the chamber Ro toward one side in the axial direction. The fluid pressure in the chamber Ro is an exemplary supply pressure and one side in the axial direction is an exemplary second direction.

The housing 11 is provided with ports 11p, 11h, 11d, and 11o in the cylinder face 11a. The ports 11p, 11h, 11d, and 11o may be referred to as openings. The ports 11p, 11h, 11d, and 11o constitute part of a fluid passage.

The port lip is open to one side in the axial direction of the cylinder face 11a, that is, to the left in FIG. 1. At the position p1, the port lip is not completely covered by the spool 12 and is open to the cylinder face 11a.

When the spool 12 is located at the position p1 as illustrated in FIG. 1, the port 11h is open to the cylinder face 11a and is covered by the large-diameter part 12a on the other side in the axial direction, or the right side in FIG. 1. When the spool 12 is located, as illustrated in FIG. 2, at a position p2 that is on the other side in the axial direction relative to the position p1, the port 11h at the foregoing position can be covered by the large-diameter part 12a on the other side in the axial direction. When the spool 12 is located, as illustrated in FIG. 3, at a position p3 that is on the other side in the axial direction relative to the position p2, the port 11h at the foregoing position communicates with the chamber Ro2.

When the spool 12 is located at the position p1 as illustrated in FIG. 1, the port 11d is open to the cylinder face 11a and communicates with the chamber Ro1. When the spool 12 is located at the position p2 as illustrated in FIG. 2, the port 11d at the foregoing position can be covered by the large-diameter part 12a on the other side in the axial direction, specifically, or on the right side in FIGS. 1 and 2. When the spool 12 is located at the position p3 as illustrated in FIG. 3, the port 11d at the foregoing position is covered by the large-diameter part 12a on the other side in the axial direction.

While the spool 12 is located at any of the positions p1 to p3 as illustrated in FIGS. 1 to 3, i.e., regardless of the position of the spool 12 within a movable range, the port 11o is open and communicates with the chamber Ro2. The port 11o communicates, via a passage 50o, with an object to be applied with fluid pressure or an object to be supplied with the fluid at a flow rate. The port 11o is an exemplary supply port. The passage 50o may be referred to as a supply passage.

The port 11h communicates with a pressure unit via a passage 50h. The pressure unit includes a pump 30 that is driven by a motor 31, and an accumulator 32. The pump 30 is, for example, a displacement pump, and suctions a fluid from a drain 33 of a reservoir, for example, and ejects the fluid to the passage 50h. A pressure in the passage 50h can be regulated to a higher level than in the drain 33. The accumulator 32 can store therein the fluid at the regulated pressure. The accumulator 32 may be referred to as a pressure accumulator. With the spool 12 at the position p3 illustrated in FIG. 3, the fluid is introduced into the chamber Ro2 via the passage 50h and an open port 11h from the pump 30 or the accumulator 32 of the pressure unit. The port 11h is an exemplary introduction port. The passage 50h may be referred to as a high-pressure passage or an introduction passage. The pump 30 and the accumulator 32 may be referred to as a high-pressure source.

The port 11d communicates with the drain 33 via a passage 50d. When the spool 12 is located at the position p1 illustrated in FIG. 1, the fluid is discharged to the drain 33 via the port 11d and the passage 50d from the chamber Ro1. The port 11d is an exemplary discharge port. The passage 50d may be referred to as a low-pressure passage or a discharge passage.

The control valve 20 includes a valve 21 that is disposed between the passage 50p communicating with the port lip and the passage 50h, and the valve 22 that is disposed between the passage 50p and the passage 50d. The valves 21 and 22 each include an electrically controlled mover (valve element, not illustrated), and change its open or closed position depending on the position of the mover. According to such structure, the larger the opening of the valve 21 is or the smaller the opening of the valve 22 is, the higher the fluid pressure in the chamber Rp is. The smaller the opening of the valve 21 is or the larger the opening of the valve 22 is, the lower the fluid pressure in the chamber Rp is. The valves 21 and 22 may be formed as valves with variable opening, such as a linear valve. The valve 21 may be referred to as a pressure increasing valve. The valve 22 may be referred to as a pressure reducing valve. The positions of the variable parts of the control valve 20, or the open or closed positions of the valves 21 and 22 such as the opening of the valves 21 and 22 and the flow rate of the fluid passing through the valves 21 and 22 are controlled by a not-illustrated control unit. The valve 21 is, for example, what is called a normally-closed type, and is thus closed when de-energized. The valve 22 is, for example, what is called a normally-open type, and is thus open when de-energized.

In addition, as illustrated in FIG. 1, a pressure sensor 41 is disposed in the passage 50h and a pressure sensor 42 is disposed in the passage 50o.

Operation of Fluid Control Valve Device FIG. 1 illustrates the valve 21 in closed state and the valve 22 in opened state. In this case, the chamber Rp communicates with the drain 33 via the chamber Rp, the port 11p, the passage 50p, the valve 22, and the passage 50d. In this case, upon receiving a larger force toward one side in the axial direction (leftward in FIG. 1) than the force toward the other side in the axial direction (rightward in FIG. 1), the spool 12 moves toward one side in the axial direction (leftward in FIG. 1) to the position p1 illustrated in FIG. 1. While the spool 12 is located at the position p1, a chamber or a passage to control (not illustrated) communicates with the drain 33 via the passage 50o, the port 11o, the chamber Ro (Ro2, Ro1), the port 11d, and the passage 50d. Thus, the fluid is discharged into the drain 33 via the fluid control valve device 1 from the chamber or the passage to control.

Although not illustrated, while the valve 21 is open and the valve 22 is closed, the chamber Rp communicates with the pump 30 or the accumulator 32 via the port 11p, the passage 50p, the valve 21, and the passage 50h. In this case, upon receiving a larger force toward the other side in the axial direction (rightward in FIG. 1) than the force toward one side in the axial direction (leftward in FIG. 1), as illustrated in FIG. 3, the spool 12 moves toward the other side in the axial direction (rightward in FIG. 3) to the position p3 illustrated in FIG. 3. While the spool 12 is located at the position p3, the not-illustrated chamber or passage to control communicates with the pump 30 or the accumulator 32 of the pressure unit via the passage 50o, the port 11o, the chamber Ro (Ro2), the port 11h, and the passage 50h. Thus, the fluid is supplied to the chamber or the passage to control from the pressure unit via the fluid control valve device 1.

When the valve 21 is opened and the valve 22 is closed from the positions in FIG. 1, or when the valve 21 illustrated in FIG. 1 is closed and the valve 22 illustrated in FIG. 1 is opened from the positions in FIG. 3, the spool 12 moves to the position p2 in accordance with the opening of the valves 21 and 22 as illustrated in FIG. 2. Under the condition in FIG. 2, the position of the spool 12 is set in accordance with equilibrium among the force from the pressure in the chamber Rp acting on the spool 12, the force from the pressure in the chamber Ro acting on the spool 12, and the force from the coil spring 14 to the spool 12. The condition illustrated in FIG. 2 may be referred to as an equilibrium. When the valves 21 and 22 maintain the open and closed positions, the condition illustrated in FIG. 2 may be referred to as a maintained condition. The position p2 may be referred to as an equilibrium position or a maintained position. the position p2 of the spool 12 is not limited to that in FIG. 2. Specifically, the spool 12 may be disposed further rightward or leftward from the position p2 illustrated in FIG. 2, depending on the open and closed positions of the valves 21 and 22.

Sliding Resistance of Spool

The inventors have found through their assiduous research that the force from sliding resistance between the spool 12 and the cylinder face 11a caused by, for example, the seal member 13, may affect the equilibrium of the spool 12. For example, when moving from the position in FIG. 1 and stopping at the position in FIG. 2, that is, moving rightward in FIGS. 1 and 2, the spool 12 stops, receiving a sliding resistance force in a direction opposite to the moving direction, that is, leftward in FIGS. 1 and 2. In the case of moving from the position in FIG. 3 to the position in FIG. 2 and stopping, that is, moving leftward in FIGS. 2 and 3, the spool 12 stops, receiving a sliding resistance force in a direction opposite to the moving direction, that is, rightward in FIGS. 2 and 3. Specifically, the inventors have found that the direction of the sliding resistance force acting on the spool 12 in the stationary state differs depending on the movement history of the spool 12.

The inventors have further found that, due to the equilibrium of forces acting on the spool 12 as described above, the spool 12 may be easier or harder to move depending on the combination of the movement history of the spool 12 and the intended moving direction of the spool 12. Specifically, when moving toward one side in the axial direction and stops, for example, the spool 12 stops, receiving the sliding resistance force in the direction opposite to the moving direction, that is, toward the other side in the axial direction (case A1). In the case A1, the seal member 13 is elastically deformed into a certain shape or posture by a force from the spool 12 and the cylinder face 11a, i.e., a force corresponding to the sliding resistance force. The shape or posture in this case will be referred to as a first shape and a first posture. In the case A1, while the spool 12 is moved toward one side in the axial direction (case A11), the direction of the force acting on the seal member 13 from the spool 12 and the cylinder face 11a does not change, so that the seal member 13 does not greatly change in shape and posture from the first shape and the first posture. Thus, the spool 12 can be relatively smoothly moved through the regulation of the pressures in the chamber Rp and the chamber Ro. In contrast, in the case A1, while the spool 12 is moved toward the other side in the axial direction (case A12), the direction of the force acting on the seal member 13 from the spool 12 and the cylinder face 11a changes, so that the seal member 13 changes from the first shape and the first posture into a second shape and a second posture which are axially opposite to the first shape and the first posture. Thus, in the case A12, along with the change in the moving direction of the spool 12, or the direction of the sliding resistance, the spool 12 is harder to move than in the case A11 since the deformation of the seal member 13 requires energy. Similarly, when the spool 12 is moved toward the other side in the axial direction and stops (case A2), the spool 12 is harder to move toward one side in the axial direction (case A21) than toward the other side in the axial direction (case A22). A similar phenomenon occurs when the direction of the sliding resistance reverses before and after the stop, regardless of the structure including the seal member 13. The similar phenomenon also occurs when the moving direction of the spool 12 quickly reverses with substantially no stop.

Controller of Fluid Control Valve Device

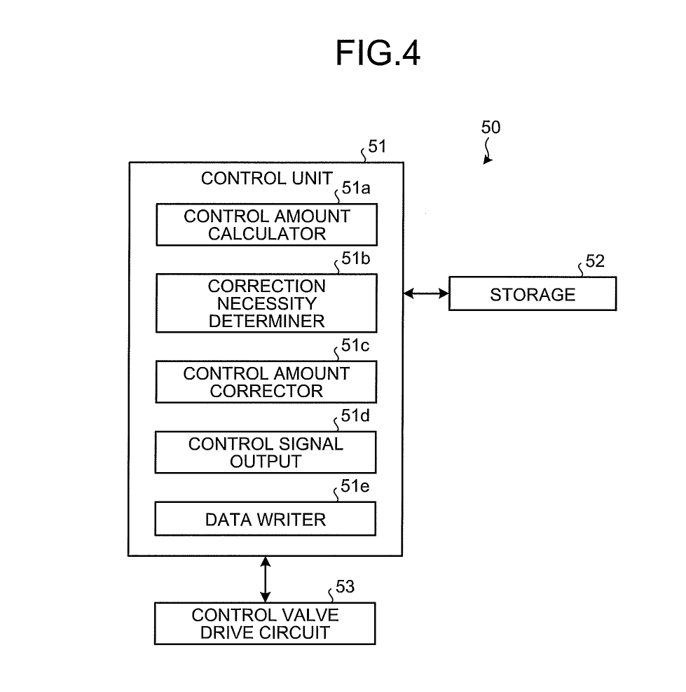

As described above, the inventors have found that the spool 12 is harder to move when the moving direction of the spool 12 reverses than when the moving direction of the spool 12 remains unchanged. In view of this, in the embodiment, a controller 50 (see FIG. 4) determines whether the moving direction of the spool 12 is to reverse on the basis of, for example, a control amount of the control valve 20 by the controller 50 and detection values of the pressure sensors 41 and 42. Upon determining that the moving direction of the spool 12 is to reverse, the controller 50 temporarily corrects the control amount at the start of the reversal to thereby temporarily increase the force applied to the spool 12 by a difference in pressure between the chamber Rp and the chamber Ro from the force corresponding to a required control amount, thereby moving the spool 12 more swiftly.

FIG. 4 is a schematic block diagram illustrating a configuration of the controller 50. The controller 50 includes a control unit 51, a storage 52, and a control-valve drive circuit 53. The controller 50 is, for example, an electronic control unit (ECU).

The control unit 51 includes, for example, a control amount calculator 51a, a correction necessity determiner 51b, a control amount corrector 51c, a control signal output 51d, and a data writer 51e.

The control amount calculator 51a calculates, on the basis of, for example, a command signal received from an external device, the control amount of the control valve 20, e.g., flow rates, openings, and positions of the valves 21 and 22. The control amount calculator 51a calculates, for example, the control amount for feedback control.

The correction necessity determiner 51b determines, on the basis of acquired data, whether the control amount needs to be corrected, i.e., whether the moving direction of the spool 12 is to start reversing. In this case, the correction necessity determiner 51b can determine whether to correct on the basis of current data and data stored in the storage 52. The data stored in the storage 52 includes history data (past data). Examples of data used for determining the necessity of correction include data indicating the control amount or status of the control valve 20, data indicating an estimated position of the spool 12, data indicating the moving direction of the spool 12, and data indicating detection values of pressure detected by the pressure sensors 41 and 42. Data indicating the control status includes, for example, data that enables the statuses of pressure increasing, pressure decreasing, and pressure maintaining to be distinguished, and may be flags associated with the respective statuses by way of example. The control amount and the control statuses are exemplary control values of the control unit 51. The estimated position and the moving direction of the spool 12 are exemplary values calculated by the control unit 51.

When the correction necessity determiner 51b determines the necessity of correction of the control amount, the control amount corrector 51c adds a correction amount to (or subtracts the correction amount from) the control amount.

The control signal output 51d outputs to the control-valve drive circuit 53 a command signal that corresponds to a corrected or non-corrected control amount.

The data writer 51e writes, to the storage 52, data for later use in determining the necessity of correction. The data serves as history data (past data) of the control amounts or the detection values at later correction-necessity determination timing. The storage 52 is, for example, a random access memory (RAM).

The control unit 51 is, for example, a central processing unit (CPU) that operates by software. At least part of the control unit 51 may be hardware, such as a field programmable gate array (FPGA), a programmable logic device (PLD), a digital signal processor (DSP), and an application specific integrated circuit (ASIC).

The control-valve drive circuit 53 receives a control signal from the control signal output 51d and applies electric power to the valves 21 and 22 in accordance with the control signal to control the operation of the valves 21 and 22.

Determination on Whether to Correct Control Amount

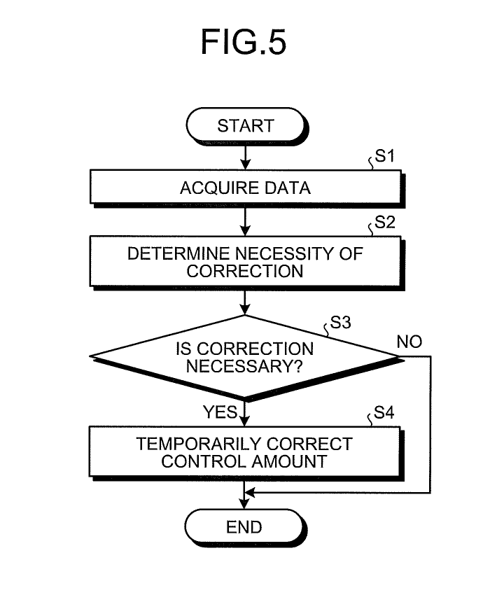

FIG. 5 is a flowchart illustrating steps performed by the correction necessity determiner 51b and the control amount corrector 51c. The correction necessity determiner 51b first acquires from, for example, the pressure sensors 41 and 42 or the storage 52, data used for determining necessity of correction (S1).

The correction necessity determiner 51b next determines the necessity of correction on the basis of the data acquired at S1 (S2).

Determination on Whether to Correct Based on History of Control Status

At S2, the correction necessity determiner 51b can determine the necessity of correction on the basis of, for example, a history of the control statuses of the valves 21 and 22, specifically, open or closed control statuses. As described above, with the valve 21 opened or the valve 22 closed, the spool 12 moves rightward in FIGS. 1 to 3. Oppositely, with the valve 21 closed or the valve 22 opened, the spool 12 moves leftward in FIGS. 1 to 3. With the valves 21 and 22 maintained at the open and closed positions to hold the spool 12 at the position p2 between the position p1 and the position p3, the spool 12 moves toward an equilibrium position corresponding to the open and closed positions of the valves 21 and 22 and stops at the equilibrium position. The data writer 51e then writes data (past data) indicating a history of control statuses (open or closed control statuses) to the storage 52 in each time step. This allows the correction necessity determiner 51b to determine the necessity of correction through a comparison of the control-status history stored in the storage 52 and the control status at the time of determination. Specifically, in the following conditions (a-1) to (a-4), the correction necessity determiner 51b can estimate the reversal of the spool 12 or the reversal thereof after the stop, and thus determine that the correction is necessary, for example.

(a-1) Pressure increasing control over the valves 21 and 22 are changed to pressure decreasing control over the valves 21 and 22. In this case, correction requirements may additionally include a condition that the valves 21 and 22 are continuously controlled under the pressure increasing control for a first threshold time or longer.

(a-2) Pressure decreasing control over the valves 21 and 22 are changed to pressure increasing control over the valves 21 and 22. In this case, correction requirements may additionally include a condition that the valves 21 and 22 are continuously controlled under the pressure decreasing control for the first threshold time or longer.

(a-3) The valves 21 and 22 are controlled under pressure maintaining control after the pressure increasing control, and the maintaining control is changed to the pressure increasing control. This is because the spool 12 under the pressure maintaining control after the stop of the pressure increasing control moves in a pressure decreasing direction (leftward in FIGS. 1 to 3). In this case, correction requirements may additionally include a condition that the valves 21 and 22 are continuously controlled under the pressure maintaining control for a second threshold time or longer.

(a-4) The valves 21 and 22 are controlled under the pressure maintaining control after the pressure decreasing control, and the maintaining control is changed to the pressure decreasing control. This is because the spool 12 under the pressure maintaining control after the stop of the pressure increasing control moves in a pressure increasing direction (rightward in FIGS. 1 to 3). In this case, correction requirements may additionally include a condition that the valves 21 and 22 are continuously controlled under the pressure maintaining control for the second threshold time or longer.

Determination on Whether to Correct Based on Estimation of Spool Position

At S2, the correction necessity determiner 51b can more accurately determine the necessity of correction on the basis of, for example, an estimated position of the spool 12. The moving direction of the spool 12 may be acquired from changes in position of the spool 12 over time or on the basis of the changes in position of the spool 12 over time and the control status of the spool 12.

Method for Estimating Spool Position (1): Position Estimation Based on Detected Pressures

The correction necessity determiner 51b can estimate the position of the spool 12 on the basis of, for example, a detection value of pressure detected by the pressure sensor 42. The pressure sensor 42 detects pressure in the chamber Ro. The pressure in the chamber Ro may be referred to as a servo pressure or a supply pressure. The pressure detection value of the pressure sensor 42 varies according to the position of the spool 12. For example, the pressure detection value of the pressure sensor 42 under the condition of FIG. 2, i.e., when the spool 12 is located at the position p2, is higher than under the condition of FIG. 1, i.e., when the spool 12 is located at the position p1. The pressure detection value of the pressure sensor 42 at the position of FIG. 3, i.e., when the spool 12 is located at the position p3, is higher than that at the position of FIG. 2, i.e., when the spool 12 is located at the position p2. The correction necessity determiner 51b can thus estimate the position of the spool 12 on the basis of the pressure detection value of the pressure sensor 42.

Specifically, for example, under the control of the control unit 51 to increase the opening of the valve 21 or decrease the opening of the valve 22, that is, under pressure increasing control, when a difference between a pressure detection value of the pressure sensor 42 at the start of the pressure increasing control (past data) and a current pressure detection value of the pressure sensor 42 is equal to or greater than a predetermined threshold, the correction necessity determiner 51b can regard the spool 12 as having reached the position p3 of FIG. 3, i.e., a pressure increasing position. In addition, for example, under the control of the control unit 51 to decrease the opening of the valve 21 or increase the opening of the valve 22, i.e., under pressure decreasing control, when a difference between a pressure detection value of the pressure sensor 42 at the start of the pressure decreasing control (past data) and a current pressure detection value of the pressure sensor 42 is equal to or greater than a predetermined threshold, the correction necessity determiner 51b can regard the spool 12 as having reached the position p1 of FIG. 1, i.e., a pressure decreasing position.

Method for Estimating Spool Position (2): Position Estimation Based on Control Amount of Control Valve during Pressure Increasing Control or Pressure Decreasing Control

The correction necessity determiner 51b can estimate the position of the spool 12 on the basis of, for example, the control amounts of the valves 21 and 22. The position of the spool 12 is an exemplary value calculated by the control unit 51. As described above, the position of the spool 12 varies depending on the control statuses, or the open and closed positions of the valves 21 and 22. Specifically, during the pressure increasing control, for example, a current position x(i) of the spool 12 can be calculated by expression (1) given below:

x(i)=x(i−1)+qᵢ×t/A (1)

where i denotes a parameter indicating a time step of calculation, i denotes a current time step and i−1 denotes a preceding time step; x(i−1) denotes the position of the spool 12 at the preceding time step i−1 (past data); qᵢ denotes the flow rate of fluid passing through the valves 21 and 22 (flow rate in pressure increasing); t denotes a calculation cycle, specifically, a time interval between time steps; and A denotes a cross-sectional area of the spool 12. The position estimation of the spool 12 by expression (1) is based on a technical idea that the spool 12 moves rightward in FIGS. 1 to 3 in accordance with the flow rate of the fluid introduced into the chamber Rp via the valves 21 and 22.

During the pressure decreasing control, the current position x(i) of the spool 12 can be calculated by expression (2) given below:

x(i)=x(i−1)+q_{d}×t/A (2)

where q_{d} denotes the flow rate of fluid passing through the valves 21 and 22 (flow rate in pressure decreasing). The position estimation of the spool 12 by expression (2) is based on a technical idea that the spool 12 moves leftward in FIGS. 1 to 3 in accordance with the flow rate of the fluid discharged from the chamber Rp via the valves 21 and 22.

Method for Estimating Spool Position (3): Position Estimation Based on Elapsed Time in Maintained State

As described above, when the positions of the valves 21 and 22 are maintained to hold the spool 12 at the position p2 between the position p1 and the position p3, the spool 12 moves toward the equilibrium position in accordance with the open and closed positions of the valves 21 and 22 and stops at the equilibrium position, after the valves 21 and 22 are maintained in position. In this case, the correction necessity determiner 51b can calculate the position of the spool 12 by, for example, expression (3) given below:

x(i)=x(i₀)+s×f(i−i₀) (3)

where i₀ denotes the time step at the start of the maintaining control of the valves 21 and 22; x(i₀) denotes the position of the spool 12 at the start of the maintaining control (past data); i−i₀ denotes the number of time steps elapsed since the start of the maintaining control of the valves 21 and 22 (elapsed time); and f(i−i₀) denotes the position of the spool 12 corresponding to the number of elapsed time steps. For example, f(i−i₀) may be set as a map indicating a function of the number of time steps and a value corresponding to the number of time steps. f(i−i₀) may be set by, for example, an experiment or simulation conducted in advance. In addition, s denotes a sign function according to the moving direction of the spool 12. For example, s is set to +1 when the moving direction of the spool 12 is rightward in FIGS. 1 to 3 (pressure increasing direction), and it is set to −1 when the moving direction of the spool 12 is leftward in FIGS. 1 to 3 (pressure decreasing direction).

During the pressure increasing control or the pressure decreasing control of the valves 21 and 22 by the controller 50, the correction necessity determiner 51b can estimate the position of the spool 12 by expression (1) or expression (2). During the pressure maintaining control of the valves 21 and 22 by the controller 50, the correction necessity determiner 51b can estimate the position of the spool 12 by expression (3).

The correction necessity determiner 51b can determine the necessity of correction on the basis of the estimated position of the spool 12. Specifically, the correction necessity determiner 51b can estimate the reversal of the spool 12 or the reversal of the spool 12 after the stop in the following conditions (b-1) to (b-4), for example, and can determine that the correction is required.

(b-1) The pressure decreasing control is initiated when the spool 12 is located at the position p3 in an immediately preceding time step. Condition (b-1) corresponds to a situation that the pressure decreasing control is initiated immediately after the end of the pressure increasing control.

(b-2) The pressure increasing control is initiated when the spool 12 is located at the position p1 in an immediately preceding time step. Condition (b-2) corresponds to a situation that the pressure increasing control is initiated immediately after the end of the pressure decreasing control.

(b-3) The pressure increasing control is initiated when the spool 12 is located at the position p2 between the position p1 and the position p3 in an immediately preceding time step and the moving direction of the spool 12 to the position p2 is the pressure decreasing direction (leftward in FIGS. 1 to 3). Condition (b-3) corresponds to situation that, after completion of the pressure increasing control, the pressure increasing control is initiated again by way of the pressure maintaining control in which the spool 12 moves in the pressure decreasing direction. In this case, correction requirements may additionally include a condition that a moving amount of the spool 12 in the pressure decreasing direction is equal to or greater than a threshold, or the valves 21 and 22 are continuously controlled under the pressure maintaining control for the second threshold time or longer.

(b-4) The pressure decreasing control is initiated when the spool 12 is located at the position p2 between the position p1 and the position p3 in an immediately preceding time step and the moving direction of the spool 12 toward the position p2 is the pressure increasing direction (rightward in FIGS. 1 to 3). Condition (b-4) corresponds to a situation that, after completion of the pressure decreasing control, the pressure decreasing control is initiated again by way of the pressure maintaining control in which the spool 12 moves in the pressure increasing direction. In this case, correction requirements may additionally include a condition that the moving amount of the spool 12 in the pressure increasing direction is equal to or greater than a threshold, or the valves 21 and 22 are continuously controlled under the pressure maintaining control for the second threshold time or longer.

Under the conditions (b-1) to (b-4) for determining the necessity of correction, the necessity for correcting the control amount can be further accurately determined, taking the estimated position of the spool 12 into account.

If the correction necessity determiner 51b determines that the control amount needs to be corrected (Yes at S3), the control amount corrector 51c temporarily corrects the control amount for a certain period of time (S4). If the correction necessity determiner 51b does not determine that the control amount needs to be corrected (No at S3), the control amount corrector 51c refrains from correcting the control amount.

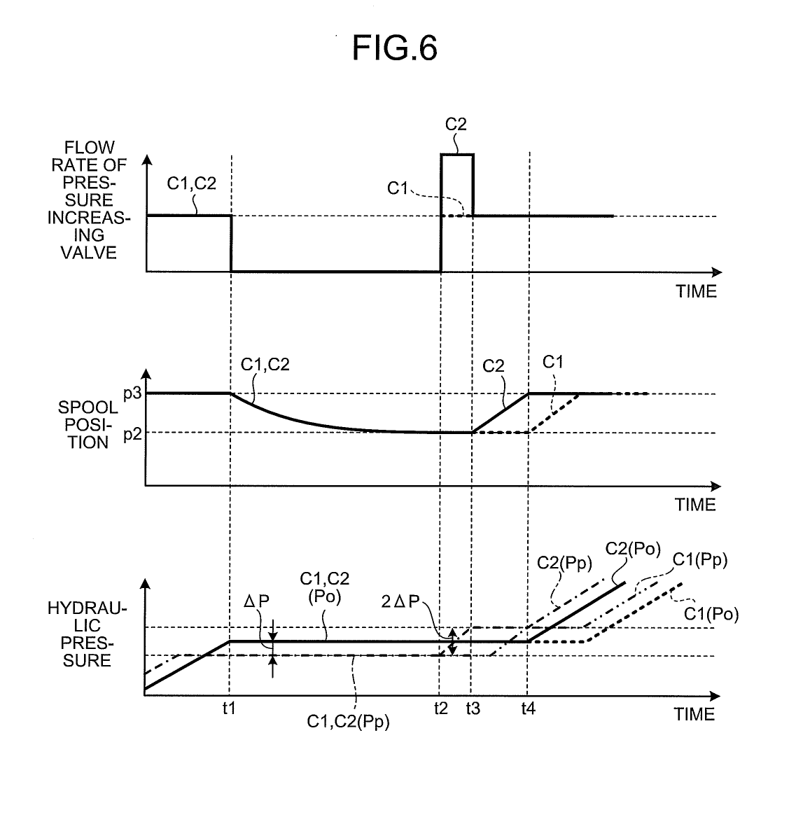

FIG. 6 is a graph depicting changes with time in the flow rate of the valve 21 (pressure increasing valve), the position of the spool 12, and fluid pressure in each of the chamber Rp and the chamber Ro when pressure increasing control transitions to pressure maintaining control and returns to pressure increasing control. C1 denotes control amount with no temporary correction (for comparison), C2 denotes control amount with temporary correction (present embodiment), Pp denotes the pressure of fluid in the chamber Rp (pilot pressure), and Po denotes the pressure of fluid in the chamber Ro (servo pressure). FIG. 6 illustrates an example that the pressure increasing control continues up to time t1, the pressure maintaining control is performed from time t1 to time t2, and the pressure increasing control starts again from time t2.

First, the changes over time in comparative example C1 with no increase in the control amount unlike the embodiment is described. During the pressure increasing control up to time t1, the valve 21 is maintained at a certain flow rate in accordance with the opening. During the pressure maintaining control from time t1 to time t2, substantially no fluid flows through the valve 21. During the pressure increasing control from time t2, the valve 21 is again maintained at the certain flow rate.

Along with the changes in the control statuses of the valves 21 and 22, the spool 12 gradually moves from the position p3 under the pressure increasing control up to time 1 to the position p2 under the pressure maintaining control up to time t2. The moving direction of the spool 12 in this case is the pressure decreasing direction.

At time t2 the pressure maintaining control over the valve 21 is switched to the pressure increasing control and the flow rate of the valve 21 is increased. However, the spool 12 move in a direction different from the moving direction before the stop (pressure decreasing direction), so that large sliding resistance occurs. Thus, with the comparative example C1, the spool 12 does not start moving until time t4 and both the pilot pressure Pp and the servo pressure Po delay in rising.

In contrast, with the embodiment C2, the flow rate (opening) of the valve 21 is temporarily corrected to an increased rate for the period from time t2 to time t3. As a result, the pilot pressure Pp increases over the period from time t2 to time t3 and the spool 12 starts moving at time t3 earlier than the moving start time t4 in comparative example C1, so that both the pilot pressure Pp and the servo pressure Po start rising earlier than in comparative example C1.

When the servo pressure Po is higher by ΔP than the pilot pressure Pp in the pressure maintaining control as illustrated in FIG. 6, the pilot pressure Pp needs to be increased to a higher pressure by ΔP than the servo pressure Po through the correction of the control amount. Thus, the pilot pressure Pp needs to be increased by 2ΔP through the correction of the control amount from time t2. This corresponds to applying twice the force of the sliding resistance to the spool 12. A control amount q_{c} from time t2 to time t3 is found by expression (4) given below.

q_{c}≥2·k·ΔP/t_{c} (4)

where q_{c} denotes a corrected flow rate; k denotes a coefficient; ΔP denotes a difference in pressure between the pilot pressure Pp and the servo pressure Po, corresponding to the sliding resistance force; and t_{c} denotes correction time (=t3−t2). The coefficient k is, for example, a reciprocal of a stiffness value of the chamber Rp. By such a correction of the control amounts of the valves 21 and 22, the sliding resistance force can act in the opposite direction due to the difference in pressure of fluids in the chambers Rp and Ro. That is, the force acting on the spool 12 in the reversed moving direction approaches the equilibrium, so that the spool 12 can move more swiftly to more quickly vary the pressure or the flow rate of the fluid to be supplied to the object to control. The valve 22 is controlled from time t2 to time t3 to increase a decrease in the flow rate or opening.

FIG. 6 illustrates an example of performing the pressure increasing control, the pressure maintaining control, and the pressure increasing control in order. However, under the pressure decreasing control, the pressure maintaining control, and the pressure decreasing control in order, similar effects can nonetheless be achieved through similar corrections of the control amounts of the valves 21 and 22. In addition, the control amounts of the valves 21 and 22 are similarly corrected, achieving similar effects when the spool 12 placed at the position p3 by the pressure increasing control is subjected to the pressure decreasing control, and when the spool 12 placed at the position p1 by the pressure decreasing control is subjected to the pressure increasing control.

As described above, in the embodiment, the control unit 51 changes the open or closed positions of the valves 21 and 22 (control valve 20) on the basis of the past data stored in the storage 52. Specifically, when the correction necessity determiner 51b determines that the control amounts (control values) of the valves 21 and 22 need to be corrected, the control amount corrector 51c corrects the control amounts. Thus, in the embodiment, in the situation that the spool 12 is hard to move, the control unit 51 can move the spool 12 more swiftly to thereby more promptly vary the pressure or flow rate of the fluid to be supplied to the object to control.

In the embodiment, upon estimating the reversal of the moving direction of the spool 12 or the reversal of the moving direction of the spool 12 before and after a stop, the control unit 51 corrects the control amounts (control values) of the valves 21 and 22. Thus, in the embodiment, for example, even when a change in the direction of the sliding resistance to the spool 12 makes it difficult for the spool 12 to move, the control unit 51 can move the spool 12 more swiftly to thereby more promptly vary the pressure or flow rate of the fluid to be supplied to the object to control.

In the embodiment, the control unit 51 can correct the control amounts (control values) of the valves 21 and 22 such that the force at least twice the sliding resistance, which acts on the spool 12, acts on the spool 12. In this case, the sliding resistance force acts in the opposite direction by the difference in pressure of fluids in the chambers Rp and Ro as a result of the changes in the open or closed positions of the valves 21 and 22, and the force acting on the spool 12 in the reversed moving direction approaches equilibrium. Thus, the control unit 51 can move the spool 12 more swiftly to thereby more quickly vary the pressure or flow rate of the fluid to be supplied to the object to control, for example.

In addition, in the embodiment, the control unit 51 can estimate the position of the spool 12 and determine the necessity of correction of the control amounts (control values) of the valves 21 and 22 on the basis of the estimated position of the spool 12. In this case, the control unit 51 can more accurately determine the necessity of correction of the control amounts (control values) on the basis of the estimated position of the spool 12, for example.

While a certain embodiment has been described, the embodiment has been presented by way of example only, and is not intended to limit the scope of the invention. Indeed, the novel configuration described herein may be embodied in a variety of other forms; furthermore, various omissions, substitutions, combinations, and changes in the form of the configuration described herein may be made without departing from the spirit of the invention. The specifications of each of the elements (structure, type, direction, shape, size, length, width, thickness, height, quantity, disposition, position, material, and the like) may be changed as appropriate. For example, the past data is not limited to that described above. The past data needs to pertain to at least one of the control value by which the control unit controls the control valve, the value calculated by the control unit, and the detection values of the sensors. The determination on the necessity of correction may be made on the basis of a detection value of any sensor other than the pressure sensors, for example.

### EXPLANATIONS OF LETTERS OR NUMERALS

1 fluid control valve device
10 spool valve
11 housing
11d port (discharge port)
11h port (introduction port)
11o port (supply port)
12 spool
20 control valve
42 pressure sensor (sensor)
51 control unit
52 storage
Pp control pressure
Rp chamber (control pressure chamber)
Po supply pressure
Ro chamber (supply pressure chamber)

1. A fluid control valve device, comprising:
a spool valve including:
a housing; and
a spool housed in the housing so as to be movable in a first direction and a second direction opposite to the first direction,
the housing and the spool defining a control pressure chamber and a supply pressure chamber,
the control pressure chamber that applies a control pressure that gives the spool a force to move in the first direction and the supply pressure chamber that applies a supply pressure that gives the spool a force to move in the second direction,
the housing provided with an introduction port, a discharge port, and a supply port,
the introduction port that is opened to introduce fluid into the supply pressure chamber when the spool moves in the first direction and is closed when the spool moves in the second direction,
the discharge port that is opened to discharge the fluid from the supply pressure chamber when the spool moves in the second direction and is closed when the spool moves in the first direction, and
the supply port that supplies the fluid from the supply pressure chamber to an object to control;
a control valve that changes an open or closed state to control pressure in the control pressure chamber;
a control unit that controls the open or closed state of the control valve in accordance with a command value; and
storage that stores therein past data on at least one of a control value by which the control unit controls the control valve, a value calculated by the control unit, and a detection value of a sensor, wherein
the control unit changes, according to the past data, the open or closed state of the control valve based on the command value.

2. The fluid control valve device according to claim 1, wherein the control unit temporarily corrects the control value based on the command value when estimating a reversal of a moving direction of the spool.

3. The fluid control valve device according to claim 1, wherein the control unit temporarily corrects the control value based on the command value when estimating a reversal of the moving direction of the spool before and after a stop of the spool.

4. The fluid control valve device according to claim 2, wherein the control unit temporarily corrects the control value based on the command value such that a force at least twice a sliding resistance, which acts on the spool, acts on the spool.

5. The fluid control valve device according to claim 2, wherein the control unit estimates a position of the spool and determines whether to temporarily correct the control value based on the command value, according to the estimated position of the spool.
